(19) United States
(12) Patent Application Publication
(10) Pub. No.: US 2015/0198312 A1
(43) Pub. Date: Jul. 16, 2015

(54) Light Mounting Device

(71) Applicant: Robert Hargrove, Bozeman, MT (US)

(72) Inventor: Robert Hargrove, Bozeman, MT (US)

(21) Appl. No.: 14/596,694

(22) Filed: Jan. 14, 2015

Related U.S. Application Data
(60) Provisional application No. 61/927,131, filed on Jan. 14, 2014.

(51) Int. Cl. F21V 21/008; F21V 21/08

(52) U.S. Cl. CPC F21V 21/008; F21V 21/0808

(57) ABSTRACT

A light mounting device for exterior lights is disclosed herein. In one embodiment, the light mounting device comprises at least one wire support and an elongated wire attached thereto. The wire support includes a substantially triangular cross section with a defined back section having adhesives thereon. In this way, the wire support can be adhesively mounted onto a surface such as the exterior of a building. The wire further includes a plurality of light supports slideably attached thereto. The light supports include a first section and a second section that can be folded together to form a gap between. The gap is adapted to hold a portion of exterior lights therein. In an exemplary embodiment, the present invention is configured for use with string lights.

### CROSS REFERENCE TO RELATED APPLICATION

This application claims the benefit of U.S. Provisional Application No. 61/927,131 filed on Jan. 14, 2014. The above identified patent application is herein incorporated by reference in its entirety to provide continuity of disclosure.

### FIELD OF THE INVENTION

The present invention relates to a light mounting device. More specifically, the present invention pertains to an improved a holding and mounting device for outdoor string lights.

### BACKGROUND OF THE INVENTION

The tradition of decorating a home during festivities and during the holidays has been long established. While many types of ornaments such as wreaths, Christmas trees, and patio displays are used, string lights have been one of the most popular decorations. It is increasingly common to completely outline the house with string lights during various holidays, namely during Christmas, Halloween, and Valentine's Day, among others.

Installing holiday decorations such as string lights requires individuals to climb ladders and roofs to hang the lights with various types of fasteners while carrying various tools. This can be a difficult and a dangerous process, as many individuals do not feel comfortable climbing ladders and roofs. Additionally, even experienced individuals can fall from a ladder or high elevation while on a roof. This is particularly true during cold weather as the ladder and the roof can become icy. Furthermore, it can be burdensome to install, remove, and reinstall string lights on the exterior of the house as some individuals desire to decorate their houses frequently. Accordingly, a reusable device that enables individuals to install, remove, and reinstall decorative lights in a safe and a convenient manner is desired.

### DRESCRIPTION OF THE PRIOR ART

Devices have been disclosed in the prior art that claim fasteners and mounting systems for decorative lights. These include devices that have been patented and published in patent application publications. Some of these devices disclose an elongated housing for holding Christmas lights therein. The elongated housing generally comprises a rectangular cross section with a hollow interior for receiving Christmas lights therein. The housing is configured to span the length of an exterior wall of a building on which it is attached. The housing further comprises a plurality of slots so that the light bulbs on the Christmas lights are visible from the exterior of the housing. The housing is directly attached to the exterior walls of the building via fasteners such as screws or nails. In contrast, the present invention discloses at least one wire support that is adhesively attached to an exterior wall of a building. The wire support is attached to a wire having a plurality of light supports thereon. The light supports are adapted to hold portions of string lights therein. In this way, the string lights are not enclosed in a housing.

Other devices disclose individual lights that can be directly mounted to the exterior of a building. The lower end of the light bulbs includes a fastener thereon. The fastener can be directly driven into the exterior wall of the building. Alternatively, the lower end of the light bulbs can be attached to a mounting plate that is attached to the exterior wall of the building. Preferably, each of the light bulbs is in electrical communication with each other so that multiple light bulbs can be used concurrently. In contrast, the present invention is adapted for use with various types of string lights. Additionally, the present invention allows a user to install, remove, and reinstall string lights or other decorative lights for exterior use.

The devices disclosed in the prior art have several known drawbacks. These devices do not disclose a wire support having a wire attached thereto, wherein the wire comprises a plurality of light supports for holding string lights thereon. The present invention overcomes these limitations by disclosing a light mounting device that can be used to install, remove, and reinstall decorative lights. In one embodiment, the present invention is configured for use with string lights. One or more wire supports are disposed along the wire that is adapted to support a plurality of light supports thereon. The light supports loosely hold a portion of the string lights therein. The light supports can slide along the string light so as to allow a user to move adjacent light supports closer together or further apart. The string lights can be easily removed from the light supports after use, thereby eliminating the need for the user to remove the present light mounting device from the exterior of the building.

It is therefore submitted that the present invention is substantially divergent in design elements from the prior art, and consequently it is clear that there is a need in the art for an improvement to fasteners and mounting systems for decorative lights. In this regard, the instant invention substantially fulfills these needs.

### SUMMARY OF THE INVENTION

In view of the foregoing disadvantages inherent in the known types of fasteners and mounting systems for decorative lights now present in the prior art, the present invention provides a new and improved light mounting device wherein the same can be utilized for mounting lights on the exterior of a building. In one embodiment, the present invention provides at least one wire support disposed along an elongated wire, which comprises a plurality of light supports slideably attached thereto. The light supports comprise a first section and a second section that can be folded toward each other to create a gap in which a portion of string lights can be inserted. The wire support can be adhesively attached to an exterior of a building, thereby eliminating the need for tools or fasteners during an installation process. When the string lights are removed from the light supports, the wire support, the wire, and the light supports can remain secured to the exterior of the building. In this way, the string lights can be easily reinstalled by replacing the string lights in the light supports.

It is therefore an object of the invention to provide a new and improved light mounting device that has all of the advantages of the prior art and none of the disadvantages.

Another object of the present invention is to provide a new and improved light mounting device that is configured for use with string lights.

Yet another object of the present invention is to provide a new and improved light mounting device that is adapted to mount exterior lights without use of tools.

Still yet another object of the present invention is to provide a new and improved light mounting device that can be removably attached to the exterior of a building.

Still yet another object of the present invention is to provide a new and improved light mounting device wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows a perspective view of the present invention.

FIG. 2 shows a perspective view of the light support of the present invention by itself.

FIG. 3 shows a view of the light support of the present invention as mounted on a support wire.

FIG. 4 shows a view of the present invention in use.

### DETAILED DESCRIPTION OF THE INVENTION

References are made herein to the attached drawings. Like reference numerals are used throughout the drawings to depict like or similar elements of the light mounting device. For the purposes of presenting a brief and clear description of the present invention, the preferred embodiment will be discussed as used for mounting lights on the exterior of a building. The figures are intended for representative purposes only and should not be considered to be limiting in any respect.

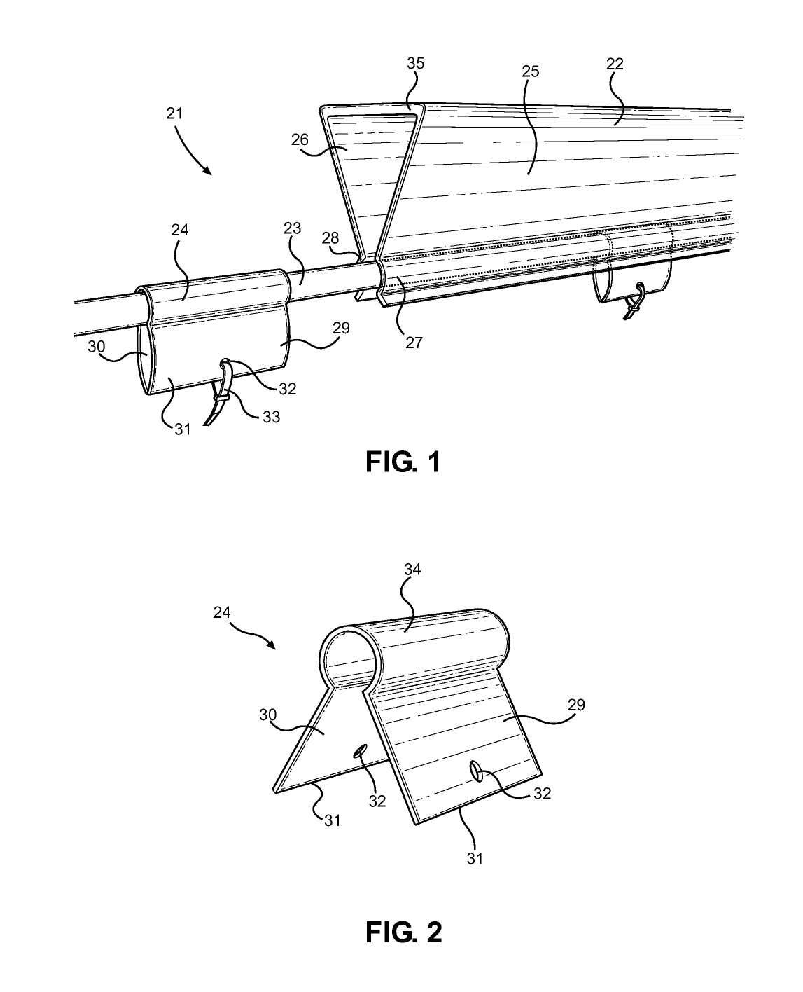

Referring now to FIG. 1, there is shown a perspective view of the present invention. The present light mounting device 21 comprises one or more wire supports 22 and a wire 23 attached thereto. In one embodiment, the wire support 22 comprises a resilient sheet metal pincher having a substantially triangular cross section. The wire support 22 comprises back section 35, a first section 25, and a second section 26. The first section 25 and the second section 26 contact each other at the first pincher grip edge 27 and a second pincher grip edge 28. The first section 25 and the second section 26 can be slightly pulled apart so as to create a space between the first pincher grip edge 27 and the second pincher grip edge 28. When released, the first pincher grip edge 27 and the second pincher grip edge 28 return to their starting position. Each of the first and second pincher grip edges 27, 28 is rounded or curved so as to create a circular channel when the first and second pincher grip edges 27, 28 meet. In this way, the first pincher grip edge 27 and the second pincher grip edge 28 are configured to slideably hold a portion of the wire 23 therebetween. More than one wire support 22 may be used and the wire supports 22 may be separated at regular intervals, depending upon embodiment. It is contemplated that more wire supports 22 are used for longer wires 23 and fewer wire supports 22 are used for shorter wires 23.

The wire 23 comprises an elongated cord having a substantially circular cross section. The wire 23 is preferably composed of a durable material. Without limitation, the wire 23 comprises a steel cable, a rope, or a silicone rubber cable, depending upon embodiment. The wire 23 comprises a plurality of light supports 24 thereon. The wire support 24 comprises a first section 29 and a second section 30 that are folded over the wire 23. The wire support 24 does not comprise an excessive thickness so that it can be held between the first and second pincher grip edges 27, 28. The wire support 24 is secured to the wire 23 via a zip tie 33 that is threaded through the apertures 32 disposed on the first and second sections 29, 30 along the edges 31 thereof. Preferably, the wire support 24 is slideably secured to the wire 23 so that it can be positioned on various locations along the wire 23.

Referring now to FIG. 2, there is shown a perspective view of the light support of the present invention by itself. The light support 24 comprises a rounded portion 34 having a first section 29 and a second section 30 extending therefrom. Each of the first section 29 and the second section 30 comprises a rectangular shape. The rounded portion 34 comprises gap so as to form a C-shaped cross section that is configured to receive a portion of the wire therein. The light support 24 is composed of a flexible material so that the first section 29 and the second section 30 can be folded toward each other until their lower edges 31 meet, creating a gap between the first section 29 and the second section 30. The gap between the first section 29 and the second section 30 is adapted to loosely hold a portion of an exterior light therein.

The first section 29 and the second section 30 can remain in a folded position via fasteners that can be threaded through the apertures 32 disposed on each of the first section 29 and the second section 30. Preferably, the apertures 32 are disposed near the lower edges 31 of each of the first and second sections 29, 30, and the apertures 32 are directly aligned. In this way, the placement of the apertures does not interfere with the placement of the exterior light that is held between the first section 29 and the second section 30.

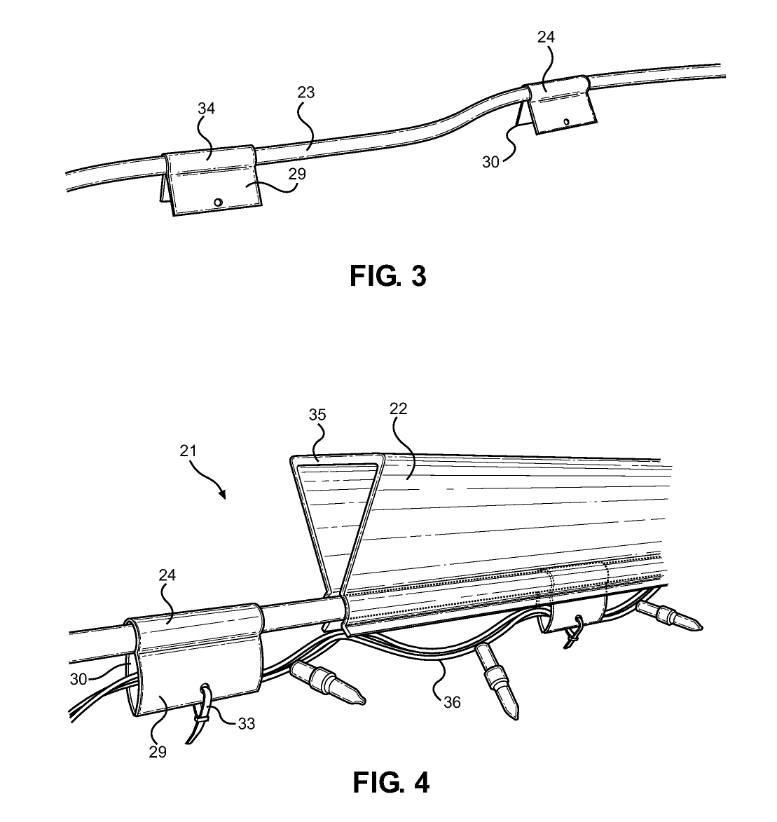

Referring now to FIG. 3, there is shown a view of the light support 24 of the present invention as mounted on the wire 23. The wire 23 is secured within the rounded portion 34 of the light support 24 so that the first section 29 and the second section 30 of the light support 24 are pointed downwards. The wire 23 comprises as many light supports 24 as needed or as desired by the user. It is contemplated that more light supports 24 may be used for heavier exterior lighting and fewer light supports 24 may be used for lighter exterior lighting. The light supports 24 can be positioned so that they are separated at regular intervals. Alternatively, the light supports 24 are slideably attached to the wire 23 so that they can be moved closer together or further apart.

FIG. 4 shows a view of the present invention in use. In some embodiments, the back section 35 of the wire support 22 comprises adhesives thereon. Preferably, strong and durable adhesives that are resistant to water or weather proof is used. The back section 35 can further comprise a protective backing layer that can be removed. In this way, the wire support 22, the wire, and the light supports 24 can be mounted to the exterior of a building without use of tools. In other embodiments, one or more fasteners can be driven through the back section 35 to mount the wire support 22, the wire, and the light supports 24 to the exterior of a building. The wire support 22 can be mounted to vertical surfaces such as the exterior wall of the building along the edges thereof, or to horizontal surfaces such as the underside of the edges of the roof.

In the illustrated embodiment, the exterior lights comprise string lights 36. The string lights 26 are positioned between the first section 29 and the second section 30 of the light supports 24. The lower edges of the first section 29 and the second section 30 remain in contact via a zip tie 33 or other similar fasteners. The light supports 24 can be evenly spaced along the string lights 26 to ensure that the lights 26 do not sag. Subsequently, the zip ties 33 can be removed so as to release the string lights 26. In this way, the present invention allows the user to easily and conveniently install string lights 26 without usage of fasteners. Additionally, the present light mounting device 21 can remain mounted to the exterior of the building year-around and be reused with various types of exterior lights.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A light mounting device, comprising:
at least one wire support having a first pincher grip edge and a second pincher grip edge;
a wire between said first pincher grip edge and said second pincher grip edge;
a plurality of light supports on said wire;
said plurality of light supports adapted to loosely hold exterior lights therein.

2. The light mounting device of claim 1, wherein said at least one wire support comprises a back section, a first section, and a second section to form a triangular cross section.

3. The light mounting device of claim 2, wherein said back section of said at least one wire support comprises adhesives thereon such that said at least one wire support can be adhesively mounted to an exterior of a building.

4. The light mounting device of claim 2, wherein said first section comprises said first pincher grip edge and said second section comprises said second pincher grip edge.

5. The light mounting device of claim 1, said plurality of light supports comprising a rounded portion having a first section and a second section extending downward therefrom;
said rounded portion adapted to receive a portion of said wire therein;
said first section and said second section folded toward each other such that a lower end of said first section and a lower end of said second section meet to form a gap therebetween;
wherein said gap is adapted to hold a portion of said exterior lights therein.

6. The light mounting device of claim 5, wherein each of said first section of said plurality of light supports and said second section of said plurality of light supports comprises an aperture for receiving a fastener therethrough.

7. The light mounting device of claim 6, wherein said aperture of said first section and said aperture of said second section are directly aligned when said first section and said second section are folded toward each other.

8. The light mounting device of claim 5, wherein each of said first section of said plurality of light supports and said second section of said plurality of light supports comprises a rectangular shape.
